(19) United States
(12) Patent Application Publication
(10) Pub. No.: US 2009/0054035 A1
(43) Pub. Date: Feb. 26, 2009

(54) SYSTEM AND METHOD FOR PROVIDING LOCATION BASED SERVICES IN A MOBILE COMMUNICATION SYSTEM

(75) Inventors: Jun-Hyung Kim, Suwon-si (KR); Ji-Cheol Lee, Yongin-si (KR); Jung-Shin Park, Seoul (KR); Nae-Hyun Lim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., LTD, Suwon-si (KR)

(21) Appl. No.: 11/925,542

(22) Filed: Oct. 26, 2007

(30) Foreign Application Priority Data
Aug. 20, 2007 (KR) 83674/2007

(51) Int. Cl. H04M 1/66; H04Q 7/20

(52) U.S. Cl. 455/411; 455/412.1; 455/440; 455/456.3

(57) ABSTRACT

A method for providing Location Based Services (LBS) in a mobile communication system is provided. Upon receipt of a location trigger for requesting location information of a Mobile Station (MS) from a location client, a Location Server (LS) transmits an authentication request message for requesting an identifier (ID) of an anchor authenticator for the MS to an Authorization, Authentication and Accounting server (AAA). Upon receipt of the authentication request message, the AAA transmits an authentication response message including an ID of the anchor authenticator to the LS. Upon receipt of the authentication response message, the LS transmits a Location Controller Identifier (LCID) request message for requesting an LCID of a Location Controller (LC) for the MS to the anchor authenticator. Upon receipt of the LCID request message, the anchor authenticator transmits an LCID response message including an LCID of the serving LC to the LS. Upon receipt of the LCID response message, the LS transmits a location report request message for requesting a report on location information of the MS to the serving LC. Upon receipt of the location report request message, the serving LC transmits a location report response message including location information of the MS to the LS.

### PRIORITY

This application claims priority under 35 U.S.C. § 119(a) to a Korean Patent Application filed in the Korean Intellectual Property Office on Aug. 20, 2007 and assigned Serial No. 2007-83674, the disclosure of which is incorporated herein by reference.

### BACKGROUND OF THE INVENTION

1. Field of the Invention

The present invention relates generally to a system and a method for providing Location Based Services (LBS) in a mobile communication system.

2. Description of the Related Art

Mobile communication systems are evolving into advanced systems that provide not only existing voice services but also various value-added services differentiated from the voice services. In the current mobile communication market, voice service-based service providers have reached a profit limit. Therefore, service providers now pursue profits by providing various value-added services differentiated from the voice service, such as, for example, Location Based Services (LBS) which are based on location information of a Mobile Station (MS). For example, typical LBS include a friend-finding service, a location-finding service, a car navigation service, etc.

With the development of mobile communication systems, the services provided in a mobile communication system are diversified requiring high-speed transmission/reception of high-volume data to increase its performance. In current mobile communication systems, active research is being conducted on various standards to transmit/receive high-volume data at high speed. One such standard, a Worldwide Interoperability for Microwave Access (WiMAX) Forum Network Working Group standard, is now undergoing standardization.

There is currently an increase in user demand for LBS, however, no detailed scheme for providing the LBS has been proposed in the WiMAX Forum Network Working Group standard. Therefore, there is a need for a scheme for providing the LBS in a mobile communication system using the WiMAX Forum Network Working Group standard.

### SUMMARY OF THE INVENTION

The present invention has been made to address at least the above problems and/or disadvantages and to provide at least the advantages described below. Accordingly, an aspect of the present invention provides a system and a method for providing LBS in a mobile communication system.

According to one aspect of the present invention, a method for providing LBS in a mobile communication system is provided. Upon receipt of a location trigger for requesting location information of a Mobile Station (MS) from a location client, an authentication request message for requesting an identifier (ID) of an anchor authenticator for the MS is transmitted by a Location Server (LS) to an Authorization, Authentication and Accounting server (AAA). Upon receipt of the authentication request message, an authentication response message including an ID of the anchor authenticator is transmitted by the AAA to the LS. Upon receipt of the authentication response message, a Location Controller Identifier (LCID) request message for requesting an LCID of a Location Controller (LC) for the MS is transmitted by the LS to the anchor authenticator. Upon receipt of the LCID request message, an LCID response message including an LCID of the serving LC is transmitted by the anchor authenticator to the LS. Upon receipt of the LCID response message, a location report request message for requesting a report on location information of the MS is transmitted by the LS to the serving LC. Upon receipt of the location report request message, a location report response message including location information of the MS is transmitted by the serving LC to the LS.

According to another aspect of the present invention, a method for providing LBS by an LS in a mobile communication system is provided. Upon receipt of a location trigger for requesting location information of an MS from a location client, an authentication request message for requesting an ID of an anchor authenticator for the MS is transmitted to an AAA. After transmitting the authentication request message, an authentication response message including an ID of the anchor authenticator is received from the AAA. Upon receipt of the authentication response message, an LCID request message for requesting an LCID of a serving LC for the MS is transmitted to the anchor authenticator. After transmitting the LCID request message, an LCID response message including an LCID of the serving LC is received from the anchor authenticator. Upon receipt of the LCID response message, a location report request message for requesting a report on location information of the MS is transmitted to the serving LC. After transmitting the location report request message, a location report response message including location information of the MS is received from the serving LC.

According to a further aspect of the present invention, a method for providing LBS by an anchor authenticator in a mobile communication system is provided. An LCID request message for requesting an LCID of a serving LC for an MS is received from an LS. Upon receipt of the LCID request message, an LCID response message including an LCID of the serving LC is transmitted to the LS. The MS is an MS whose location information is required according to a location trigger of a location client.

According to yet another aspect of the present invention, a method for providing LBS by an LC in a mobile communication system is provided. A location report request message for requesting a report on location information of an MS is received from an LS by a serving LC. Upon receipt of the location report request message, a location report response message including location information of the MS is transmitted by the serving LC to the LS. The MS is an MS whose location information is required according to a location trigger of a location client.

According to an additional aspect of the present invention, a system for providing LBS in a mobile communication system is provided. The LBS provisioning system includes an LS for receiving a location trigger for requesting location information of an MS from a location client. The LS transmits an authentication request message for requesting an ID of an anchor authenticator for the MS to an AAA. The LS receives an authentication response message from the AAA and transmits an LCID request message for requesting an LCID of an LC for the MS to the anchor authenticator. The LS receives an LCID response message and transmits a location report request message for requesting a report on location information of the MS to the serving LC. The LS receives a location report response message including location information of the MS from the serving LC. The LBS provisioning system also includes the AAA for receiving the authentication request message from the LS, and transmitting the authentication response message including an ID of the anchor authenticator to the LS. The LBS provisioning system further includes the anchor authenticator for receiving the LCID request message from the LS, and transmitting the LCID response message including an LCID of the serving LC to the LS. The LBS provisioning system finally includes the serving LC for receiving the location report request message, and transmitting the location report response message including location information of the MS to the LS.

### BRIEF DESCRIPTION OF THE DRAWINGS

The above and other aspects, features and advantages of the present invention will become more apparent from the following detailed description when taken in conjunction with the accompanying drawings, in which:

FIG. 1 is a block diagram illustrating a configuration of an LBS provisioning system according to an embodiment of the present invention; and

FIG. 2 is a flow diagram illustrating a process of determining a serving LC of an MS in a connected mode in an LBS provisioning system according to an embodiment of the present invention.

### DETAILED DESCRIPTION OF THE PREFERRED EMBODIMENTS

Preferred embodiments of the present invention are described in detail with reference to the annexed drawings. Detailed descriptions of constructions or processes known in the art may be omitted to avoid obscuring subject matter of the present invention.

The present invention provides a system and a method for providing Location Based Services (LBS) in a mobile communication system. Although the present invention will be described herein with reference to the mobile communication system using the Worldwide Interoperability for Microwave Access (WiMAX) Forum Network Working Group standard, by way of example, it is not intended to limit the present invention thereto.

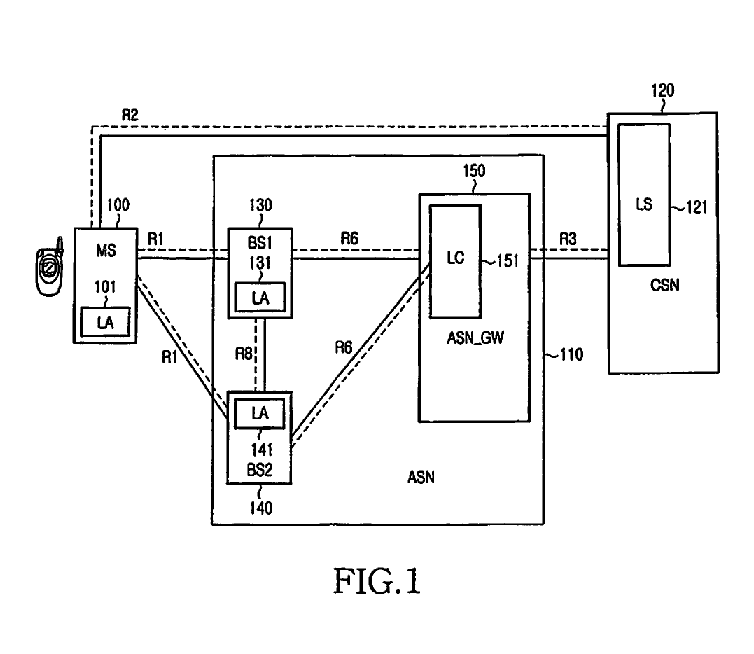

FIG. 1 illustrates a configuration of an LBS provisioning system according to an embodiment of the present invention.

Referring to FIG. 1, the LBS provisioning system includes a Mobile Station (MS) 100, an Access Services Network (ASN) 110, and a Connectivity Services Network (CSN) 120. The ASN 110 includes a first Base Station (BS1) 130, a second Base Station (BS2) 140, and an ASN Gateway (ASN_GW) 150. An interface scheme between the MS 100 and the BS1 130 and BS2 140 is an R1 interface scheme. An interface scheme between the MS 100 and the CSN 120 is an R2 interface scheme. An interface scheme between the ASN_GW 150 and the CSN 120 is an R3 interface scheme. An interface scheme between the BS1 130 and the ASN_GW 150 and between the BS2 140 and the ASN_GW 150 is an R6 interface scheme. An interface scheme between the BS1 130 and the BS2 140 is an R8 interface scheme. The R1 interface scheme, the R2 interface scheme, the R3 interface scheme, the R6 interface scheme and the R8 interface scheme are not directly related to the present invention, so a detailed description thereof will be omitted herein.

The CSN 120 includes a Location Server (LS) 121. The LS 121 provides location information of the MS 100 to internal authorized entities of an operator network, or external authorized entities of the operator network. Herein, the operator network refers to a network using the WIMAX Forum Network Working Group standard (WiMAX network), and the authorized entity refers to an entity having the authority to request location information of the MS 100, for example, an LBS client. Further, the internal LBS client refers to an LBS client existing inside the WIMAX network, and the external LBS client refers to an LBS client existing outside the WiMAX network.

The ASN_GW 150 includes a Location Controller (LC) 151, which triggers a network initiated LBS process when there is an inquiry request from the exterior. More specifically, the LC 151 triggers the network initiated LBS process upon receipt of an external inquiry request for location information of the MS 100. The LS 121 stores an identifier (ID) of an LC, for example, LC 151, connected to a serving ASN, for example, ASN 110, of the MS 100. Herein, the LC included in the serving ASN is a serving LC, thus the LC 151 is a serving LC of the MS 100. The LS 121 calculates a location of the MS 100 using a location measurement result on the MS 100, transmitted by the LC 151.

The LC 151, in association with the BS1 130 and the BS2 140, determines location information of the MS 100, or determines a location parameter of the MS 100. The LC 151 provides the location information of the MS 100 or the location parameter of the MS 100 to the LS 121 or the MS 100. Further, the LC 151 can provide the location information of the MS 100 or the location parameter of the MS 100 to other internal entities included in the ASN 110, such as, for example, a Radio Resource Management (RRM) entity and a Mobility Management (MM) entity. The RRM entity and MM entity are not separately shown in FIG. 1. Upon receipt of a request for location information or a location parameter of the MS 100 from the MS 100 and the LS 121 or other entities included in the ASN 110, the LC 151 triggers location measurement on the MS 100 and collects all data necessary for location decision on the MS 100. The LC 151 previously knows a serving BS of the MS 100, and provides information on the serving BS of the MS 100 to the LS 121.

A Location Agent (LA) performs location measurement, or selectively collects the data necessary for location decision. The LA provides location-related data to the LC 151. Herein, the LA can be included in the MS 100, the BS1 130 and the BS2 140: the LA included in the MS 100 is an LA 101, the LA included in the BS1 130 is an LA 131, and the LA included in the BS2 140 is an LA 141. When an LA is disposed in the MS, an LA corresponding thereto is disposed in the BS.

Although not illustrated in FIG. 1, the CSN 120 includes an Authorization, Authentication and Accounting server (AAA), which manages an anchor authenticator's ID of the MS 100. The anchor authenticator manages an ID of the serving LC of the MS 100, and is included in the ASN 110. In particular, the anchor authenticator can be located either inside or outside the ASN_GW 150 in the ASN 110. For convenience, it will be assumed herein that the anchor authenticator is located outside the ASN_GW 150.

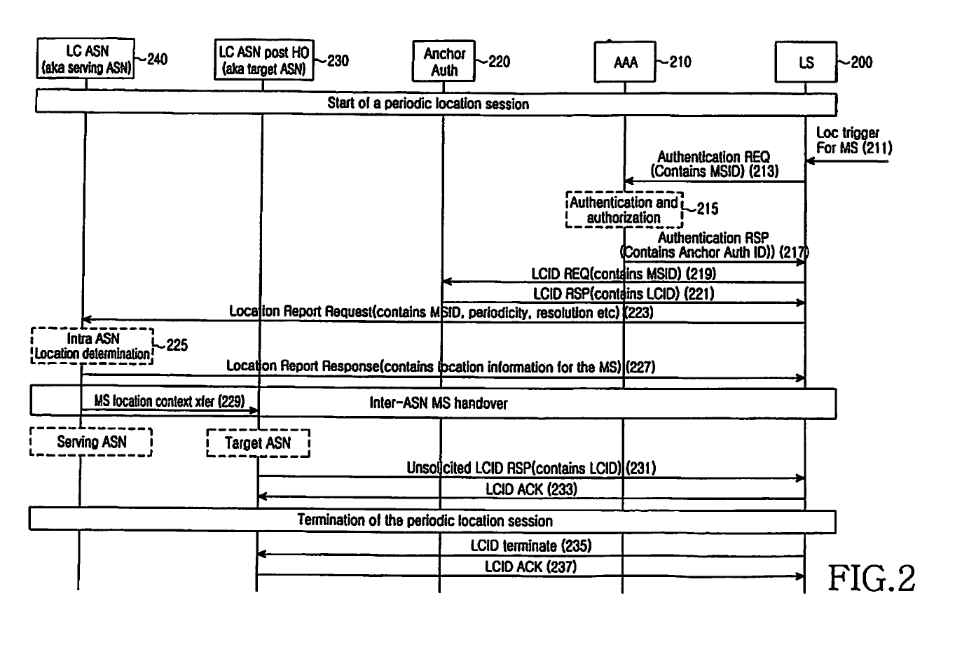

With reference to FIG. 2, a description is provided of a process of determining a serving LC of an MS in a connected mode in an LBS provisioning system according to an embodiment of the present invention.

FIG. 2 illustrates a process of determining a serving LC of an MS in a connected mode in an LBS provisioning system according to an embodiment of the present invention.

To determine a location of an MS, an LS should first determine an effective LC (i.e. serving LC) of the MS. That is, the LS should determine an LCID of the serving LC to determine a location of the MS. For convenience, the serving LC of the MS will be referred to as a ‘serving LC’ for short. A process in which the LS determines an LCID of the serving LC includes the following push and pull components.

(1) LC_ID Pull

To start a periodic location information request or an aperiodic location information request for an MS, the LS determines an LCID of the serving LC through a process with an AAA. The term ‘periodic location information request’ as used herein refers to an action in which the serving LC requests the LS to periodically report the location information of the MS. The term ‘aperiodic location information request’ refers to an action in which the serving LC requests the LS to report the location information of the MS aperiodically, i.e. on a one-time basis. When the MS is in the connected mode, the AAA provides the LS with an anchor authenticator ID of the MS to allow the LS to determine a serving ASN of the MS. For convenience, the serving ASN of the MS will be referred to as a ‘servingASN’ for short.

(2) LC_ID Push

In some cases, when the LS transmits a request for periodic location information to the serving LC, the serving LC should transmit an LCID of a new LC other than the serving LC separately while periodically providing the location information of the MS to the LS. This case corresponds, for example, to the case where an MS in the connected mode performs inter-ASN handover, and in this case, the new LC (i.e. target LC) in a target ASN of the MS should transmit an LCID of the target LC to the LS. For convenience, the target ASN of the MS will be referred to as a ‘target ASN’ for short. The LS updates the LCID managed by the LS itself with the LCID of the target LC, received from the target LC. In this manner, a location context is transmitted from the serving ASN to the target ASN along with other Type/Length/Value (TLV) information during the inter-ASN handover process.

When the LS intends to terminate the periodic location information request, it can terminate the LCID update at the LS through the LC_ID push using an LCID terminate message.

Referring to FIG. 2, an LS 200 receives a location trigger for requesting location information of an MS (not shown) from a location client (Loc trigger for MS) in step 211. The location client refers to an entity for requesting location information of an MS, and the location client can be disposed either inside or outside the WiMAX network. The location client disposed inside the WiMAX network is the internal authorized entity described in FIG. 1, while the location client disposed outside the WiMAX network is the external authorized entity described in FIG. 1. Upon receipt of the location trigger, the LS 200 transmits an Authentication request (Authentication REQ) message to an AAA 210 (Authentication REQ (Contains MSID)) in step 213. The Authentication REQ message, a message for requesting an anchor authenticator identifier for the MS, includes an identifier (i.e. MSID) of the MS, location information of which the LS 200 intends to acquire. Upon receiving the Authentication REQ message, the AAA 210 performs an authentication and authorization operation using the MSID included in the Authentication REQ message (Authentication and authorization) in step 215. The authentication operation refers to an operation of determining whether the location client has a qualification to request the location information of the MS, and the authorization operation indicates an operation of determining whether it is possible to open the location information of the MS to the location client.

After successfully performing the authentication and authorization operation, the AAA 210 transmits an Authentication response (Authentication RSP) message to the LS 200 (Authentication RSP (Contains Anchor Auth ID)) in step 217. Herein, the Authentication RSP message, a response message to the Authentication REQ message, includes an anchor authenticator ID of the MS. Although not shown in FIG. 2, as a result of the authentication and authorization operation performed by the AAA 210, if the location client has no qualification to request the location information of the MS or it is not possible to open the location information of the MS to the location client, the AAA 210 transmits the information indicating the failure in the authentication and authorization operation to the LS 200 along with the Authentication RSP message. Then the LS 200 transmits a notification indicating the failure in the location trigger to the location client. Although the AAA 210 performs the authentication and authorization operation in FIG. 2, by way of example, the AAA 210 can omit the authentication and authorization when necessary. Upon receipt of the Authentication RSP message, the LS 200 can detect an anchor authenticator ID of the MS from the received Authentication RSP message. Therefore, the LS 200 transmits an LCID request (LCID REQ) message to an anchor authenticator (i.e. anchor authenticator 220) corresponding to the anchor authenticator ID (LCID REQ (Contains MSID)) in step 219. The LCID REQ message, a message for requesting an LCID for a serving LC of the MS, includes an MSID of the MS.

After receiving the LCID REQ message, the anchor authenticator 220 transmits an LCID response (LCID RSP) message to the LS 200 (LCID RSP (Contains LCID)) in step 221. The LCID RSP message includes an LCID for the serving LC. Upon receipt of the LCID RSP message, the LS 200 can determine the serving LC of the MS. Therefore, the LS 200 transmits a Location Report Request message to the serving LC (i.e. serving LC 240) of the MS (Location Report Request (contains MSID, periodicity, resolution, etc.)) in step 223. It should be noted that the serving LC 240 is shown as an LC ASN (aka serving ASN) 240 in FIG. 2. The Location Report Request message, a message for requesting a report on location information for the MS, is assumed to include (i) an MSID of the MS, (ii) report period (periodicity) information indicating a report period by which location information of the MS is to be reported, and (iii) duration information indicating the total time interval for which the periodic report is to be performed. When the report period information is written as a preset value (e.g. ‘0’), it indicates that there is no need to periodically report the location information for the MS. It will be assumed that when the report period information is written as ‘0’, the duration information is also written as a preset value (e.g. ‘0’).

Upon receipt of the Location Report Request message, the serving LC 240 starts a location decision operation for the MS. That is, the serving LC 240 performs an intra-ASN procedure for location decision on the MS (intra ASN Location determination) in step 225. Thereafter, in step 227, the serving LC 240 transmits location information for the MS to the LS 200 along with a Location Report Response message (Location Report Response (contains location information for the MS)). When the report period information included in the Location Report Request message is not the set value, i.e. when the location information of the MS should be periodically reported, the serving LC 240 periodically transmits the Location Report Response message to the LS 200, until the MS leaves the serving LC 240, the duration included in the Location Report Request message expires, or the LS 200 determines to terminate a periodic location session. The term ‘periodic location session’ as used herein refers to a session in which the serving LC 240 periodically transmits the Location Report Response message to the LS 200.

When the MS performs inter-ASN handover (Inter-ASN MS handover) while the serving LC 240 periodically transmits the Location Report Response message, the serving LC 240 transmits a context for the periodic location session to a target LC 230 (MS location context xfer) in step 229. The ‘context for the periodic location session’ is given to provide seamless LBS for the MS during handover of the MS, and includes location information (e.g. latitude information, longitude information, altitude information, etc.) for a serving BS of the MS, and current relative delay information between the MS and the BS. When the inter-ASN handover of the MS is terminated in this way, the target LC 230 transmits an Unsolicited LCID RSP message to the LS 200 (Unsolicited LCID RSP (contains LCID)) in step 231. The Unsolicited LCID RSP message includes an LCID of the target LC 230, and is transmitted to enable the LS 200 to constantly update the LC to which the MS now belongs. Upon receipt of the Unsolicited LCID RSP message, the LS 200 transmits an LCID acknowledgement (LCID ACK) message indicating the normal receipt of the Unsolicited LCID RSP message to the target LC 230 in step 233. Although not separately illustrated in FIG. 2, the target LC 230 also reports the location information of the MS to the LS 200, until the MS leaves the target LC 230, the duration expires, or the LS 200 determines to terminate the periodic location session.

When there is an intention to terminate the periodic location session (Termination of the periodic location session), the LS 200 transmits an LCID terminate message to the target LC 230 to prevent the target LC 230 from any longer periodically reporting the location information of the MS in step 235. Upon receipt of the LCID terminate message, the target LC 230 transmits an LCID ACK message indicating the normal receipt of the LCID terminate message to the LS 200 in step 237. Although the LS 200 transmits the LCID terminate message to the target LC 230 to terminate the periodic location session in FIG. 2, by way of example, the LS 200 can transmit the LCID terminate message to the serving LC 240 to terminate the periodic location session.

As is apparent from the foregoing description, the present invention enables LBS provision in the mobile communication system employing the WiMAX Forum Network Working Group standard. Therefore, the present invention enables provisioning of various LBS-based services in the mobile communication system employing the WiMAX Forum Network Working Group standard, thereby giving service providers an opportunity for new profits, enabling the user to receive various LBS-based services, and thus contributing to popularization of the WiMAX service.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for providing Location Based Services (LBS) in a mobile communication system, the method comprising the steps of:
upon receipt of a location trigger at a Location Server (LS) for requesting location information of a Mobile Station (MS) from a location client, transmitting an authentication request message for requesting an identifier (ID) of an anchor authenticator for the MS from the LS to an Authorization, Authentication and Accounting server (AAA);
upon receipt of the authentication request message at the AAA, transmitting an authentication response message including an ID of the anchor authenticator from the AAA to the LS;
upon receipt of the authentication response message at the LS, transmitting a Location Controller Identifier (LCID) request message for requesting an LCID of a Location Controller (LC) for the MS from the LS to the anchor authenticator;
upon receipt of the LCID request message at the anchor authenticator, transmitting an LCID response message including an LCID of the serving LC from the anchor authenticator to the LS;
upon receipt of the LCID response message at the LS, transmitting a location report request message for requesting a report on location information of the MS from the LS to the serving LC; and
upon receipt of the location report request message at the serving LC, transmitting a location report response message including location information of the MS from the serving LC to the LS.

2. The method of claim 1, wherein the location report request message includes report period information indicating a report period by which the serving LC will report the location information of the MS, and duration information indicating a total time interval for which the serving LC will periodically report the location information of the MS.

3. The method of claim 2, wherein the transmitting a location report response message comprises:
after receiving the location report request message, transmitting a location report response message including location information of the MS to the LS; and
transmitting the location information of the MS to the LS along with the location report response message at every report period for the total time interval using the report period information and the duration information, wherein transmitting the location information is defined as a periodic location session process.

4. The method of claim 3, further comprising:
transmitting a context for a periodic location session to a target LC of the MS, upon detecting that the MS performs inter-Access Services Network (ASN) handover while the serving LC performs the periodic location session process.

5. The method of claim 4, wherein the periodic location session context includes an ID of the LS, the report period information, and the duration information.

6. The method of claim 5, further comprising:
upon receipt of the periodic location session context, transmitting an unsolicited LCID response message including an ID of the target LC from the target LC to the LS.

7. The method of claim 6, further comprising:
upon receipt of the unsolicited LCID response message at the LS, updating by the LS an LC, to which the MS now belongs, from the serving LC to the target LC.

8. The method of claim 6, further comprising:
after transmitting the unsolicited LCID response message, transmitting the location information of the MS from the target LC to the LS along with the location report response message at every report period for the total time interval using the report period information and the duration information, wherein transmitting the location information is defined as a periodic location session process.

9. The method of claim 1, wherein the MS is an MS in a connected mode.

10. A method for providing Location Based Services (LBS) by a Location Server (LS) in a mobile communication system, the method comprising the steps of:
upon receipt of a location trigger for requesting location information of a Mobile Station (MS) from a location client, transmitting an authentication request message for requesting an identifier (ID) of an anchor authenticator for the MS to an Authorization, Authentication and Accounting server (AAA);
after transmitting the authentication request message, receiving an authentication response message including an ID of the anchor authenticator from the AAA;
upon receipt of the authentication response message, transmitting to the anchor authenticator a Location Controller Identifier (LCID) request message for requesting an LCID of a serving Location Controller (LC) for the MS;
after transmitting the LCID request message, receiving an LCID response message including an LCID of the serving LC from the anchor authenticator;
upon receipt of the LCID response message, transmitting to the serving LC a location report request message for requesting a report on location information of the MS; and
after transmitting the location report request message, receiving a location report response message including location information of the MS from the serving LC.

11. The method of claim 10, wherein the location report request message includes report period information indicating a report period by which the serving LC will report the location information of the MS, and duration information indicating a total time interval for which the serving LC will periodically report the location information of the MS.

12. The method of claim 11, wherein the receiving a location report response message comprises:
receiving a location report response message including location information of the MS from the serving LC; and
receiving thereafter a location report response message including location information of the MS from the serving LC at every report period for the total time interval, wherein receiving a location report response message is defined as a periodic location session process.

13. The method of claim 12, further comprising:
receiving from a target LC an unsolicited LCID response message including an LCID of the target LC while performing the periodic location session process;
wherein the target LC is a new LC determined as the MS performs inter-Access Services Network (ASN) handover while the LS performs the periodic location session process.

14. The method of claim 10, wherein the MS is an MS in a connected mode.

15. A method for providing Location Based Services (LBS) by an anchor authenticator in a mobile communication system, the method comprising the steps of:
receiving a Location Controller Identifier (LCID) request message for requesting an LCID of a serving Location Controller (LC) for a Mobile Station (MS); and
upon receipt of the LCID request message, transmitting an LCID response message including an LCID of the serving LC to the LS;
wherein the MS is an MS whose location information is required according to a location trigger of a location client.

16. A method for providing Location Based Services (LBS) by a Location Controller (LC) in a mobile communication system, the method comprising the steps of:
receiving by a serving LC a location report request message for requesting a report on location information of a Mobile Station (MS) from a Location Server (LS); and
upon receipt of the location report request message, transmitting by the serving LC a location report response message including location information of the MS to the LS;
wherein the MS is an MS whose location information is required according to a location trigger of a location client.

17. The method of claim 16, wherein the location report request message includes report period information indicating a report period by which the LC will report the location information of the MS, and duration information indicating a total time interval for which the LC will periodically report the location information of the MS.

18. The method of claim 17, wherein the transmitting a location report response message comprises:
after receiving the location report request message, transmitting by the serving LC a location report response message including location information of the MS to the LS; and
transmitting by the serving LC the location information of the MS to the LS along with the location report response message at every report period for the total time interval using the report period information and the duration information, wherein the transmitting the location information is defined as a periodic location session process.

19. The method of claim 18, further comprising:
transmitting a context for a periodic location session to a target LC of the MS, upon detecting that the MS performs inter-Access Services Network (ASN) handover while the serving LC performs the periodic location session process.

20. The method of claim 19, wherein the periodic location session context includes an ID of the LS, the report period information, and the duration information.

21. A system for providing Location Based Services (LBS) in a mobile communication system, the system comprising:
a Location Server (LS) for receiving a location trigger for requesting location information of a Mobile Station (MS) from a location client, transmitting an authentication request message for requesting an identifier (ID) of an anchor authenticator for the MS to an Authorization, Authentication and Accounting server (AAA), receiving an authentication response message from the AAA, transmitting a Location Controller Identifier (LCID) request message for requesting an LCID of a Location Controller (LC) for the MS to the anchor authenticator, receiving an LCID response message, transmitting a location report request message for requesting a report on location information of the MS to the serving LC, and receiving a location report response message including location information of the MS from the serving LC;
the AAA for receiving the authentication request message from the LS, and transmitting the authentication response message including an ID of the anchor authenticator to the LS;
the anchor authenticator for receiving the LCID request message from the LS, and transmitting the LCID response message including an LCID of the serving LC to the LS; and
the serving LC for receiving the location report request message, and transmitting the location report response message including location information of the MS to the LS.

22. The system of claim 21, wherein the location report request message includes report period information indicating a report period by which the serving LC will report the location information of the MS, and duration information indicating a total time interval for which the serving LC will periodically report the location information of the MS.

23. The system of claim 22, wherein the serving LC transmits the location report response message, and performs a periodic location session process as an operation for transmitting the location information of the MS to the LS along with the location report response message at every report period for the total time interval using the report period information and the duration information.

24. The system of claim 23, further comprising:
a target LC;
wherein the serving LC transmits a context for a periodic location session to the target LC of the MS, upon detecting that the MS performs inter-Access Services Network (ASN) handover while the serving LC performs the periodic location session process.

25. The system of claim 24, wherein the periodic location session context includes an ID of the LS, the report period information, and the duration information.
